(19) United States
(12) Patent Application Publication
(10) Pub. No.: US 2018/0267350 A1
(43) Pub. Date: Sep. 20, 2018

(54) LIQUID CRYSTAL DISPLAY DEVICE

(71) Applicant: Sharp Kabushiki Kaisha, Sakai City, Osaka (JP)

(72) Inventors: Takehisa SAKURAI, Sakai City (JP); Mayuko SAKAMOTO, Sakai City (JP)

(21) Appl. No.: 15/517,216

(22) PCT Filed: Nov. 10, 2015
(86) PCT No.: PCT/JP2015/081546

§ 371 Date: Apr. 6, 2017

(30) Foreign Application Priority Data
Nov. 17, 2014 (JP) 2014-232818

(51) Int. Cl. G02F 1/133; G02F 1/1335; G02F 1/1333; G02F 1/1343; G09G 3/36

(52) U.S. Cl. CPC G02F 1/13306; G02F 1/133528; G02F 1/133512; G02F 1/1343; G09G 3/36; G02F 1/133345

(57) ABSTRACT

A liquid crystal display device includes a first circuit board, a second circuit board, a liquid crystal layer, a light transmitting display area, a memory circuit, a liquid crystal driving voltage applying circuit, and a potential applying trace. The first circuit board includes a light reflecting electrode. The second circuit board includes a common electrode. The light transmitting display area is for transmitting light from an outer side of the first circuit board through the first circuit board. The memory circuit stores data based on a potential at a data signal trace. The liquid crystal driving voltage applying circuit is for adjusting a potential at the light reflecting electrode based on the data stored in the memory circuit. The potential applying trace includes an overlapping portion overlapping the light transmitting display area between the glass substrate and the first insulating film and is electrically connected to the memory circuit.

### TECHNICAL FIELD

The present invention relates to a liquid crystal display device.

### BACKGROUND ART

An example of conventional liquid crystal display devices is disclosed in Patent Document 1. The liquid crystal display device disclosed in Patent Document 1 includes a reflecting display area and a transmitting display area. In the reflecting display area, an image is displayed by reflecting ambient light. According to the configuration, power consumption can be reduced. In the transmitting display area, an image is displayed using light emitted by a backlight. According to the configuration, visibility in a dark environment improves.

### RELATED ART DOCUMENT

### Patent Document

Patent Document 1: Japanese Unexamined Patent Application Publication No. 2012-255908

### Problem to be Solved by the Invention

The liquid crystal display device includes memories in pixels, respectively. The liquid crystal display device is configured to display an image using data stored in the memories. According to the configuration, the number of rewriting electrical potentials of signals for pixel electrodes can be reduced and thus power consumption can be reduced. However, the configuration including the memories, conductive traces for transmitting the signals to the memories are required. The conductive traces are connected to the memories in the pixels, respectively. Portions of the conductive traces overlap the transmitting display area. In the transmitting display area, an orientation of liquid crystals in a liquid crystal layer may be altered due to potential differences between the conductive traces and a common electrode. The alteration may cause a bright dot defect or a flicker, that is, display quality may decrease.

### DISCLOSURE OF THE PRESENT INVENTION

The present invention was made in view of the above circumstances. An object is to restrict a decrease in display quality.

### Means for Solving the Problem

A liquid crystal display device includes a transparent substrate, a first circuit board, a second circuit board, a liquid crystal layer, a light transmitting display area, a data signal trace, a memory portion, a potential adjusting portion, and at least one trace. The first circuit board includes a first insulating film, a second insulating film, and a light reflecting electrode. The first insulating film is formed on the transparent substrate. The second insulating film is formed on the first insulating film. The light reflecting electrode is formed on the second insulating film for reflecting light to be used for display. The second circuit board includes a common electrode opposed to the light reflecting electrode. The liquid crystal layer is between the first circuit board and the second circuit board. In the light transmitting display area, light enters from an outer side of the first circuit board and transmits through the first circuit board to be provided for display. The data signal trace is included in the first circuit board and receives a data signal. The memory portion is included in the first circuit board and stores data based on an electrical potential at the data signal trace. The potential adjusting portion is included in the first circuit board and adjusts an electrical potential at the light reflecting electrode based on the data stored in the memory portion. The trace is included in the first circuit board. The trace includes an overlapping portion overlapping the light transmitting display area. The trace is arranged between the transparent substrate and the first insulating film and electrically connected to at least one of the memory portion and the potential adjusting portion.

According to the present invention, the first insulating film and the second insulating film are between the overlapping portion of the trace and the liquid crystal layer. In comparison to a configuration that does not include the first insulating film and the second insulating film, the overlapping portion is isolated from the liquid crystal layer. Therefore, an orientation of the liquid crystals in the liquid crystal layer is less likely to be altered due to a potential difference between the overlapping portion and the common electrode. A bright dot defect or a flicker is less likely to be produced in a portion of the light transmitting display area corresponding to the overlapping portion and thus a higher display quality is achieved. “The first insulating film is formed on the transparent substrate” includes a condition that the first insulating film is on a liquid crystal layer side relative to the transparent substrate and not in contact with the transparent substrate. “The second insulating film is formed on the first insulating film” includes a condition that the second insulating film is on the liquid crystal layer side relative to the first insulating film and not in contact with the first insulating film.

A square-wave pulse signal may be applied to the common electrode. The trace may include a memory-side potential applying trace for applying a constant level of electrical potential to the memory portion. In general, when a voltage with the same polarity is applied to the liquid crystals for a long period, the liquid crystals may be degraded. To avoid such a problem, the polarity of the voltage applied to the liquid crystals may be altered with time. To alter the polarity with time, pulse signals in antiphase may be applied to the light reflecting electrode and the common electrode, respectively. In the application of the pulse signal to the common electrode, if the electrical potential at the trace (the memory-side potential applying trace) is constant, the potential difference between the trace and the common electrode varies with time (with pulse width). If the potential difference between the trace and the common electrode affect the orientation of the liquid crystals, a black display and a white display may periodically alternate in an area corresponding to the overlapping portion of the trace, resulting in a flicker. According to the present invention, the first insulating film and the second insulating film are between the overlapping portion of the trace and the liquid crystal layer. Therefore, the orientation of the liquid crystals in the liquid crystal layer is less likely to be altered due to the potential difference between the overlapping portion and the common electrode and thus the flicker is less likely to be produced.

The liquid crystal display device may operate in normally white mode. The potential adjusting portion may be configured to apply one of a first potential and a second potential that is in antiphase with the first potential to the light reflecting electrode based on the data stored in the memory portion. The trace may include at least first potential applying trace for applying the first potential to the potential adjusting portion. A potential the same as the potential at the common electrode may be applied to the first potential applying trace.

According to the configuration, the potential difference between the first potential applying trace and the common electrode is constantly zero. In normally white mode, if the potential difference between the first potential applying trace and the common electrode affects the orientation of the liquid crystals in the liquid crystal layer, the area corresponding to the overlapping portion of the first potential applying trace may be constantly white regardless of the potential at the light reflecting electrode. In the liquid crystal display device, the white area corresponding to the overlapping portion of the first potential applying trace during the black display may be detected as a bright dot defect. According to the present invention, the first insulating film and the second insulating film are between the overlapping portion of the first potential applying trace and the liquid crystal layer. Therefore, the orientation of the liquid crystals in the liquid crystal layer is less likely to be altered due to the potential difference between the first potential applying trace and the common electrode and thus the bright spot defect is less likely to be produced.

The liquid crystal display device may operate in normally black mode. The potential control portion may be configured to apply one of a first potential and a second potential that is in antiphase with the first potential to the light reflecting electrode based on the data stored in the memory portion. The trace may include at least first potential applying trace for applying the first potential to the potential adjusting portion. A potential that is in antiphase with the potential at the common electrode may be applied to the first potential applying trace.

According to the configuration, the potential difference is constantly produced between the first potential applying trace and the common electrode. If the potential difference between the first potential applying trace and the common electrode affects the orientation of the liquid crystals in the liquid crystal layer in normally black mode, the area corresponding to the overlapping portion of the first potential applying trace may be constantly white regardless of the potential at the light reflecting electrode. In the liquid crystal display device, if the area corresponding to the first potential applying trace is white during the black display, the area may be detected as a bright dot defect. According to the present invention, the first insulating film and the second insulating film are between the first potential applying trace and the liquid crystal layer. Therefore, the orientation of the liquid crystals in the liquid crystal layer is less likely to alter due to the potential difference between the first electrode applying trace and the common electrode and thus the bright dot defect is less likely to be produced.

The second circuit board may include a light blocking portion for blocking light traveling to the second circuit board. The light blocking portion may be formed at a position overlapping the overlapping portion. The trace may include at least two traces included in the first circuit board. The light blocking portion may cover overlapping portions of the traces adjacent to each other. The light blocking portion may have a dimension in a direction in which the overlapping portions are arranged adjacent to each other larger than a sum of dimensions of the overlapping portions and a distance between the overlapping portions in the direction.

According to the configuration, the area corresponding to the light blocking portion (the overlapping portion) is constantly black in the liquid crystal display device. Therefore, the flicker or the bright spot defect is further less likely to be produced due to the potential at the overlapping portion in the area corresponding to the overlapping portion. In comparison to a configuration in which the overlapping portions are independently covered with light blocking portions, light may leak through a gap between the light blocking portions. According to the present invention, two overlapping portions are covered with a single light blocking portion. Therefore, the leak of light is less likely to occur and thus higher display quality is achieved.

To properly block the light traveling to the second circuit board with the light blocking portion, it is preferable to set the dimension of the light blocking portion larger than the dimension of the overlapping portion such that the light blocking portion includes a portion to cover peripheries of the overlapping portions (a peripheral portion). To independently cover two overlapping portions that are not adjacent to each other, it is preferable to provide such a peripheral portion for each light blocking portion. Therefore, a total area of the light blocking portions is more likely to be large. According to the present invention, the overlapping portions are adjacent to each other and covered with a single light blocking portion. In comparison to the configuration in which two overlapping portions that are not adjacent to each other are independently covered with the light blocking portions, the peripheral portion (more specifically, a portion corresponding to the gap between the overlapping portions) is reduced in size. Therefore, the area of the light blocking portion can be reduced and the light use efficiency improves.

The liquid crystal display device may further include a spacer between the first circuit board and the second circuit board for maintaining a gap between the first circuit board and the second circuit board. The second circuit board may include a light blocking portion for blocking light traveling to the second circuit board. The light blocking portion may be formed at a position overlapping the overlapping portion. The spacer may overlap the overlapping portion.

It is difficult to control the orientation of the liquid crystals around the spacer and thus the display quality may decrease. With the light blocking portion overlapping the spacer, the spacer and the overlapping portion is covered with a single light blocking portion. In comparison to a configuration in which a spacer and an overlapping portions that are separately arranged are covered with separate light overlapping portions, respectively, the area of the light blocking portion can be reduced and thus the light use efficiently further improves.

### Advantageous Effect of the Invention

According to the present invention, a decrease in display quality can be restricted.

### BRIEF DESCRIPTION OF THE DRAWINGS

FIG. 1 is a schematic cross-sectional view illustrating a cross section of a liquid crystal display device according to a first embodiment of the present invention cut along a long-side direction.

FIG. 2 is a schematic plan view of a liquid crystal panel included in the liquid crystal display device.

FIG. 3 is a plan view of a first circuit board included in the liquid crystal display device.

FIG. 4 is a schematic cross-sectional view illustrating a cross-sectional configuration of the liquid crystal panel (cut along line IV-IV in FIG. 3).

FIG. 5 is a schematic cross-sectional view illustrating a cross-sectional configuration of the liquid crystal panel (cut along line V-V in FIG. 3).

FIG. 6 is a circuit diagram illustrating a configuration of a pixel circuit.

FIG. 7 is a cross-sectional view illustrating n-channel transistors that form a memory circuit.

FIG. 8 is a timing chart illustrating an example of operation of the pixel circuit.

FIG. 9 is a table illustrating electrical potentials at traces and electrodes in the pixel circuit.

FIG. 10 is a plan view of a first circuit board included in a liquid crystal display device according to the second embodiment of the present invention.

FIG. 11 is a table illustrating electrical potentials at traces and electrodes in a pixel circuit according to the second embodiment.

FIG. 12 is a perspective view of a liquid crystal display device according to a third embodiment of the present invention.

### MODE FOR CARRYING OUT THE INVENTION

### First Embodiment

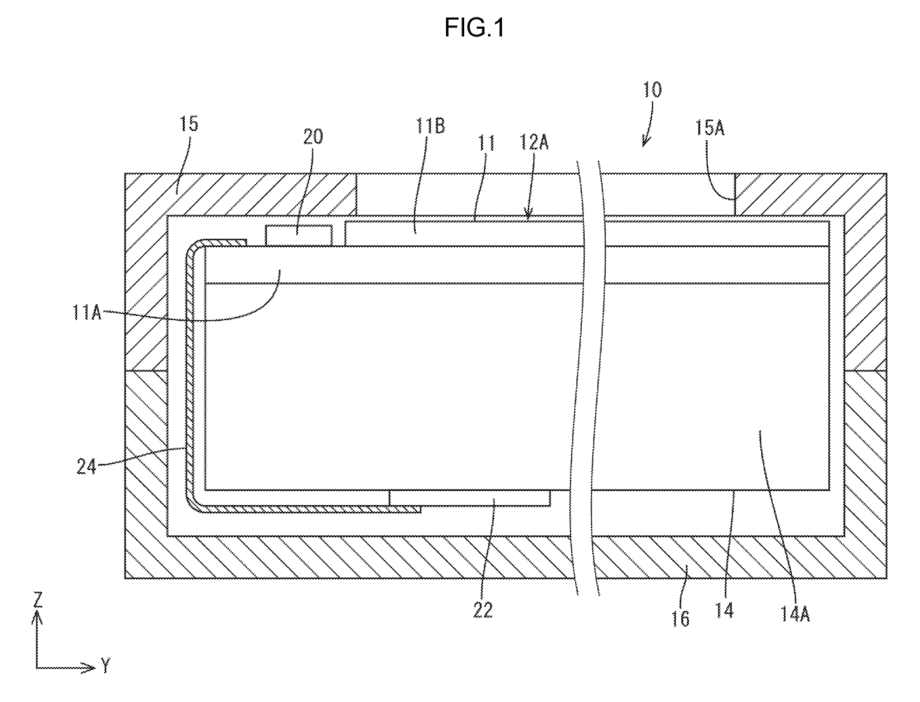

A first embodiment according to the present invention will be described with reference to FIGS. 1 to 9. In this section, a liquid crystal display device 10 including a liquid crystal panel 11 will be described. X-axis, Y-axis and Z-axis may be indicated in the drawings. The axes in each drawing correspond to the respective axes in other drawings. The vertical direction is defined based on FIG. 1. An upper side and a lower side in FIG. 1 correspond to a front side and aback side of the liquid crystal display device 10, respectively.

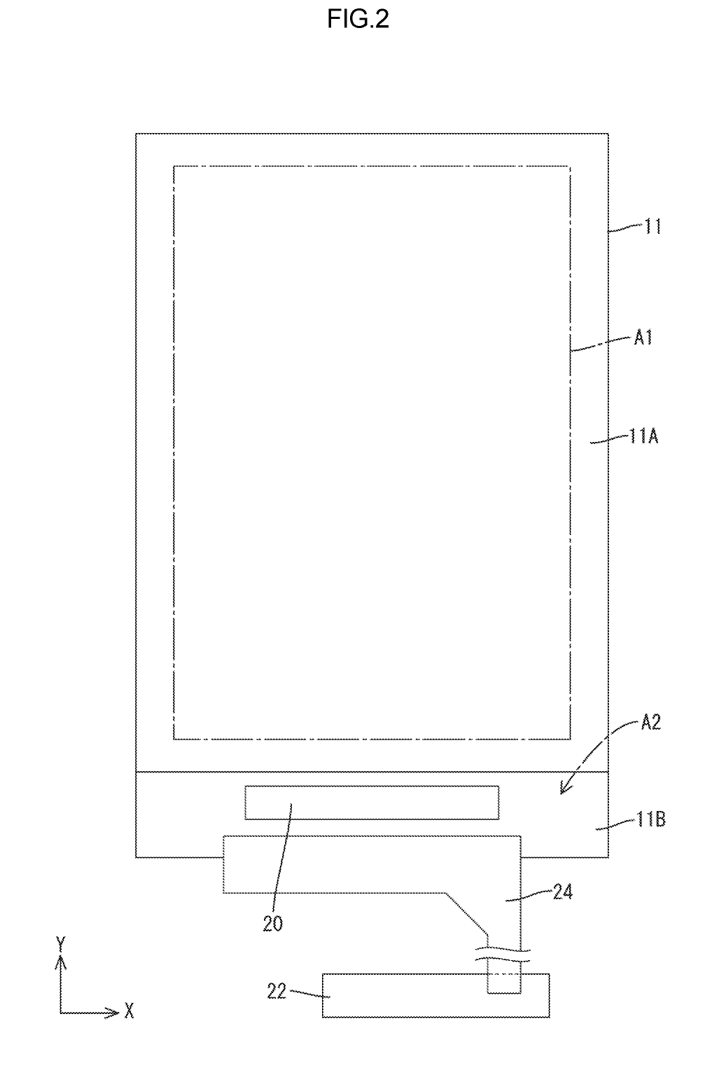

As illustrated in FIGS. 1 and 2, the liquid crystal display device 10 includes a liquid crystal panel 11, an IC chip 20, a control circuit board 22, a flexible circuit board 24, and a backlight unit 14. The IC chip 20 is an electronic component mounted on the liquid crystal panel 11 for driving the liquid crystal panel 11. The control circuit board 22 is for supplying various external signals to the IC chip 20. The flexible circuit board 24 is for electrically connecting the liquid crystal panel 11 to the control circuit board 22 that is an external component. The backlight unit 14 is an external light source for supplying light to the liquid crystal panel 11. The liquid crystal display device 10 according to this embodiment may be used for a notebook personal computer, an electronic book, a PDA, a digital photo frame, a portable video game player, or an electronic paper.

The liquid crystal display device 10 includes front and rear exterior members 15 and 16 that are used in a combination for holding the liquid crystal panel 11 and the backlight unit 14 that are assembled together inside the exterior members 15 and 16. The front exterior member 15 includes an opening 15A through which an image displayed on the liquid crystal panel 11 is viewed from the outside. The liquid crystal panel 11 is a semitransmissive liquid crystal panel configured to perform reflecting display and transmitting display. The reflecting display uses external light (surrounding light, ambient light) applied from a display surface 12 side (a front side, a light exiting side) and reflected. The transmitting display uses light applied by the backlight unit 14 (backlight) and transmitted. The external light used in the reflecting display includes sunlight and room light.

As illustrated in FIG. 1, the backlight unit 14 includes a chassis 14A, a light source (e.g., cold cathode-ray tubes, LEDs, organic ELs, not illustrated), and an optical member (not illustrated). The chassis 14A has a substantially box shape with an opening on the front side. The light source is disposed inside the chassis 14A. The optical member is disposed to cover the opening of the chassis 14A. The optical member has a function for converting light emitted by the light source into planar light. The planar light, which is formed through the optical member, enters the liquid crystal panel 11. The planar light is used for displaying an image on the liquid crystal panel 11. The backlight unit 14 may include a light source and a light guide plate for guiding light from the light source to the liquid crystal panel 11.

Next, the liquid crystal panel 11 will be described. As illustrated in FIG. 2, the liquid crystal panel 11 has a vertically-long rectangular overall shape. A long-side direction of the liquid crystal panel 11 corresponds with the Y-axis direction and a short-side direction of the liquid crystal panel 11 corresponds with the X-axis direction. The liquid crystal panel 11 includes a large portion that is a display area A1 in which images are displayed and an end portion at an end of the long dimension of the liquid crystal panel 11 (a lower side in FIG. 2). The end portion is a non-display area A2 in which no image is displayed. The IC chip 20 and the flexible circuit board 24 are mounted on a portion of the non-display area A2. As illustrated in FIG. 1, the display area A1 of the liquid crystal panel 11 has a contour indicated with a chain line in a frame shape slightly smaller than a first circuit board 11A, which will be described later. An area outside the chain line is the non-display area A2. The shape of the liquid crystal panel 11 is not limited to the rectangular shape. For example, the liquid crystal panel 11 may have an octagon shape or a round shape. The shape of the display area A1 may be altered as appropriate.

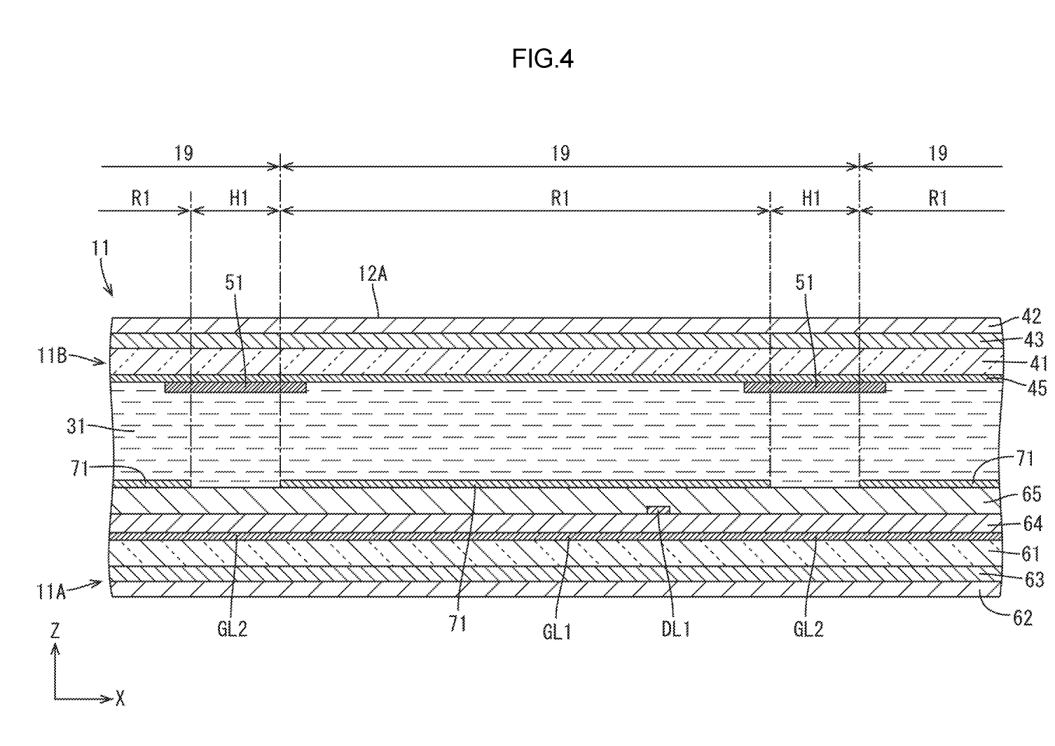

As illustrated in FIG. 4, the liquid crystal panel 11 includes a pair of circuit boards 11A and 11B having highlight transmissivity and a liquid crystal layer 31. The liquid crystal layer 31 includes liquid crystal molecules that are substances having optical characteristics that change according to application of electrical field. Among the circuit boards 11A and 11B, the first circuit board 11A on the rear side (a back side, a backlight unit 14 side) is an array board (a component board, an active-matrix board). A second circuit board 11B on the front side is a counter board. The liquid crystal panel 11 in this embodiment operates in normally white mode in which transmissivity is at a maximum and provides white display when the liquid crystal panel 11 is not turned on (no voltage is applied to a light reflecting electrode 71, which will be described later).

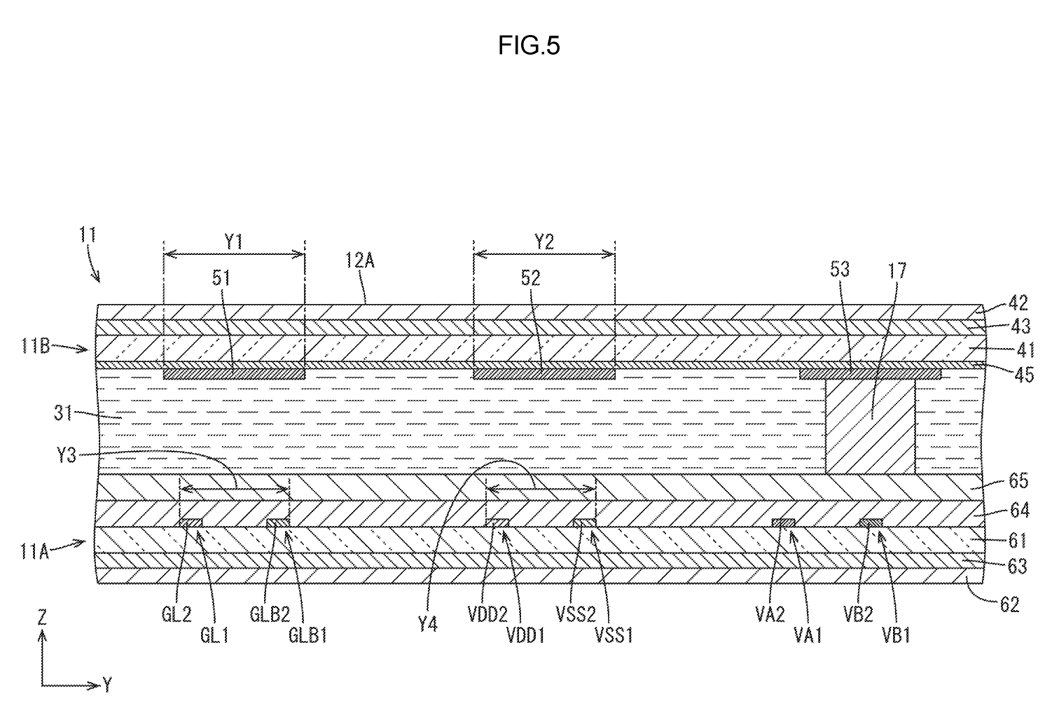

The first circuit board 11A and the second circuit board 11B are opposed to each other and bonded together with a sealing member, which is not illustrated. The liquid crystal layer 31 is between the first circuit board 11A and the second circuit board 11B. As illustrated in FIG. 5, spacers 17 each having columnar shapes are disposed between the first circuit board 11A and the second circuit board 11B. A gap between the first circuit board 11A and the second circuit board 11B is maintained with the spacers 17. The spacers 17 may be photo spacers made of photopolymer material. Each spacer 17 may have a spherical shape. Alignment films (not illustrated) are formed on inner surfaces of the circuit board 11A and 11B for aligning the liquid crystal molecules included in the liquid crystal layer 31.

As illustrated in FIG. 4, the first circuit board 11A includes a substantially transparent glass substrate 61 (a transparent substrate), a first insulating film 64, a second insulating film 65, light reflective electrodes 71, a ¼-wavelength phase plate 63, and a polarizing plate 62. The first insulating film 64 is formed on the glass substrate 61 (on a surface of the glass substrate 61 on the liquid crystal layer 31 side). The second insulating film 65 is formed on the first insulating film 64 (on a surface of the first insulating film 64 on the liquid crystal layer 31 side). The light reflecting electrodes 71 are formed on the second insulating film 65 (on a surface of the second insulating film on the liquid crystal layer 31 side). The ¼-wavelength phase plate 63 and the polarizing plate 62 are bonded to an outer surface of the glass substrate 61. The first insulating film 64 is made of inorganic material and the second insulting film 65 is made of organic material. The materials of the first insulating film 64 and the second insulating film 65 are not limited to those.

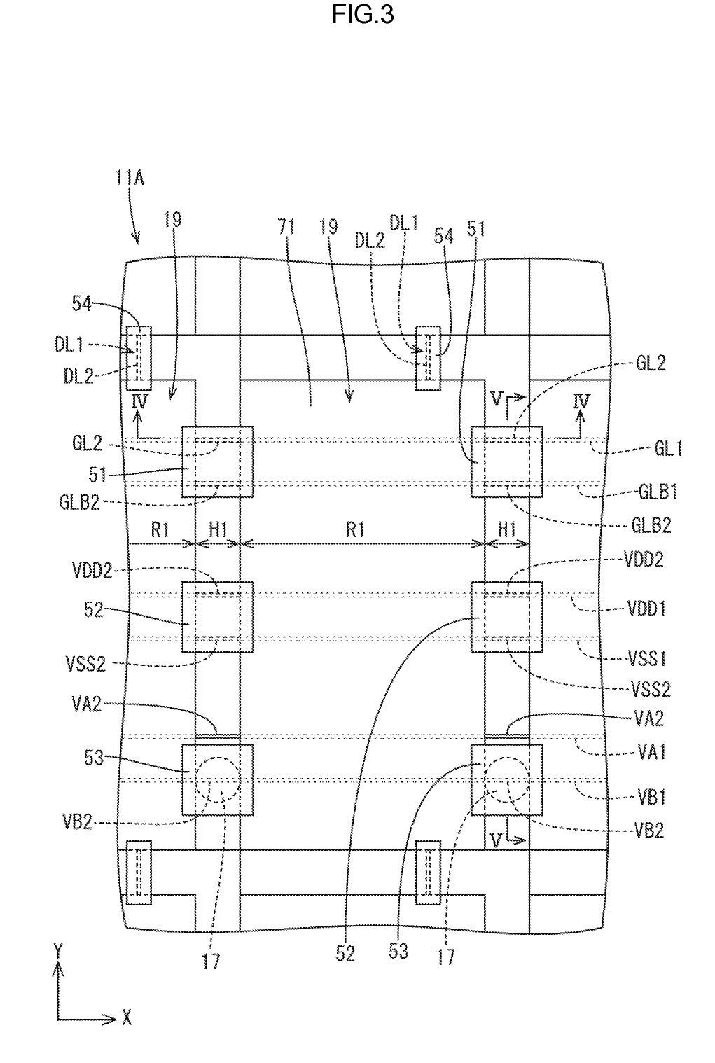

As illustrated in FIG. 3, pixels 19 are arranged in the display area A1 of the liquid crystal panel 11. The pixels 19 are two-dimensionally arranged in a matrix within a plate surface of the first circuit board 11A. The light reflecting electrodes 71 are arranged to correspond to the pixels 19, respectively. Each light reflecting electrode 71 is formed from a metal film made of metal such as aluminum. Each light reflecting electrode 71 has high light reflectivity and a rectangular shape that is long in the Y-axis direction in a plan view. External light entering from an outer side of the second circuit board 11B (an upper side in FIG. 4) is reflected by the light reflecting electrodes 71 to the second circuit board 11B and used for display. An area corresponding to the light reflecting electrodes 71 is a light reflecting display area R1 in which the external light entering from the outer side of the second circuit board 11B (from the upper side in FIG. 4) is reflected and used for display.

Areas between the adjacent light reflecting electrodes 71, 71 are light transmitting display areas H1 in which the light from the backlight unit 14 (light entering from an outer side of the first circuit board 11A) is transmitted through the first circuit board 11A and used for display. The light transmitting display areas H1 correspond to gaps between the adjacent light reflecting electrodes 71. As illustrated in FIG. 3, each light transmitting display area H1 has an L shape in a plan view. In this embodiment, the light reflecting display area R1 has an area larger than the area of the light transmitting display areas H1. The ratio of the area of the light reflecting display area R1 to the area of the light transmitting display areas H1 and the shapes in the plan view are not limited to those described above and may be altered as appropriate.

As illustrated in FIG. 5, the second circuit board 11B includes a substantially transparent glass substrate 41, a common electrode 45, a 1/4-wavelength phase plate 43, and a polarizing plate 42. A common electrode 45 (a counter electrode) is formed on a surface of the glass substrate 41 on the liquid crystal layer 31 side. The common electrode 45 is formed from a transparent conductive film such as an indium tin oxide (ITO) film. The common electrode 45 is opposed to the light reflecting electrodes 71. A predefined electrical potential (will be described later) is applied to the common electrode 45. Potential differences are produced between the common electrode 45 and the light reflecting electrodes 71. According to the configuration, the orientation of the liquid crystal molecules in the liquid crystal layer 31 can be altered based on the potential differences between the common electrode 45 and the light reflecting electrodes 71. The 1/4-wavelength phase plate 43 and the polarizing plate 42 are bonded to the outer surface of the glass substrate 41. The second circuit board 11B in this embodiment may include a color filter.

The ¼-wavelength phase plates 43 and 63 of the first circuit board 11A and the second circuit board 11B are for adjusting phase differences by switching from linear polarization to circular polarization or from circular polarization to linear polarization. Specifically, during the reflecting display using the light reflecting electrodes 71, the light transmits through the 1/4-wavelength phase plate 43 on a display surface 12A side (the upper side in FIG. 4) twice. During the transmitting display using the light transmitting display area H1, the light transmits through the 1/4-wavelength phase plate 43 once and through the 1/4-wavelength phase plate 63 on the opposite side from the display surface 12A side once. With the 1/4-wavelength phase plates 43 and 63, the light polarizing directions are 90 degrees different from each other in the reflecting display and the transmitting display. The black display performance during the reflecting display is assured and a phase difference that may be produced between the reflecting display and the transmitting display.

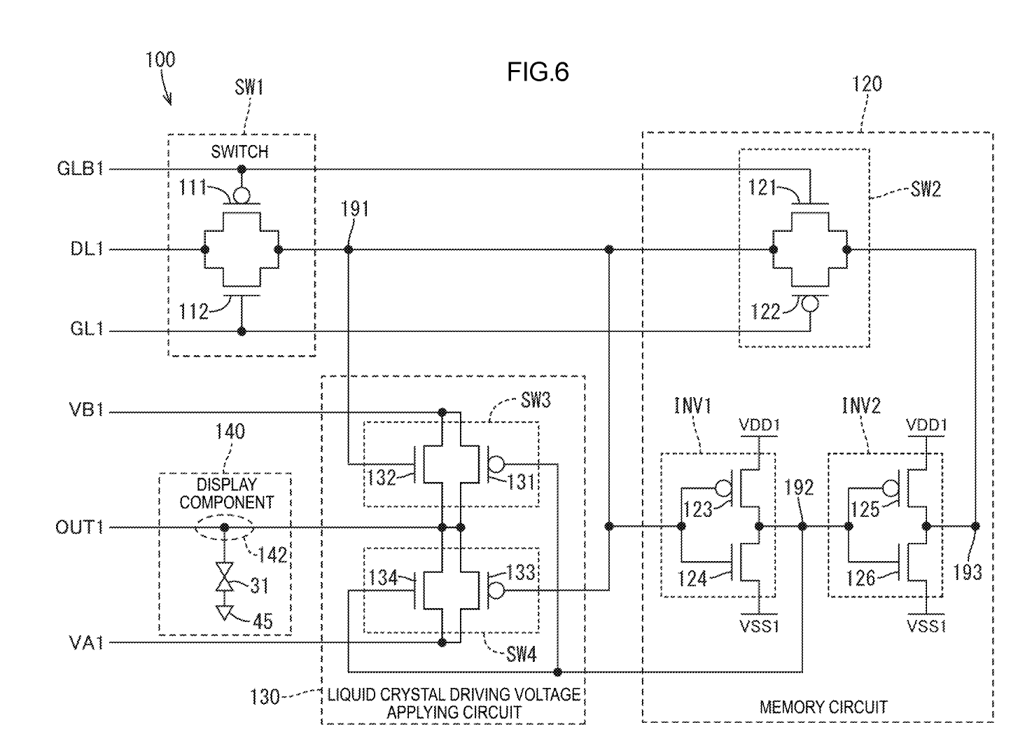

Next, an electrical configuration of this embodiment will be described. This embodiment includes pixel circuits 100 for the pixels 19, respectively. FIG. 6 is a block diagram illustrating a configuration of the pixel circuit 100. As illustrated in FIG. 6, each pixel circuit 100 includes a first switch SW1, a memory circuit 120 (a memory portion), a liquid crystal driving voltage applying circuit 130 (an electrical potential adjusting portion), and a display component 140. The pixel circuit 100 is electrically connected to the IC chip 20. The IC chip 20 includes an input interface circuit, a first voltage generating circuit, a timing generator, a second voltage generating circuit, a scan signal trace driving circuit, and a data signal trace driving circuit. The input interface circuit receives various kinds of external electrical signals. The first voltage generating circuit generates voltages applied to the light reflecting electrodes. The timing generator generates various kinds of signals for timing controls. The second voltage generating circuit generates voltages applied to the common electrode 45. The scan signal trace driving circuit drives the scan signal traces GL1 and GLB1. The data signal trace driving circuit supplies data signals to data signal traces DL1.

As illustrated in FIG. 6, the scan signal traces GL1 and GLB1 are electrically connected to the first switches SW1 and second switches SW2 in the memory circuits 120. On/off conditions of the first switches SW are controlled based on the scan signals transmitted to the first scan signal traces GL1 and the second scan signal traces GLB1. Binary data (1-bit data) is transmitted to the memory circuit based on the electrical potential of data signal at the data signal trace DL1 when the first switch SW1 is closed. The memory circuit 120 holds (or stores) the binary data received when the first switch SW1 is closed until the first switch SW1 is closed again. The binary data stored in the memory circuit 120 is transmitted to the liquid crystal driving voltage applying circuit 130.

The liquid crystal driving voltage applying circuit 130 selects either a white display potential or a black display potential (which will be described later) based on a value in the binary data (a logical value) from the memory circuit 120 and applies it to the light reflecting electrode 71. In FIG. 6, a trace for applying the black display potential (a second potential) to the liquid crystal driving voltage applying circuit 130 is a potential applying trace VA1 and a trace for applying the white display potential (a first potential) to the liquid crystal driving voltage applying circuit 130 is a potential applying trace VB1 (a first potential applying trace). The potential applying trace VA1, the potential applying trace VB1 are electrically connected to the liquid crystal driving voltage applying circuit 130.

As illustrated in FIG. 6, the first switch SW1 is a CMOS switch including a p-channel transistor 111 and an n-channel transistor 112. The first switch SW1 is configured to be closed when the signal at the first scan signal trace GL1 is high and the signal at the second scan signal trace GLB1 (a second scan signal) is low. In this embodiment, a high level of the first scan signal is an on-level for closing the first switch SW1 and a low level of the second scan signal is an on-level for closing the first switch SW1. In the following description, the signal at the first scan signal trace GL1 (the first scan signal) may be indicated with reference sign GL1 and the signal at the second scan signal trace GLB1 (the second scan signal) may be indicated with reference sign GLB1.

When the switch SW1 is closed, the data signal trace DL1 is electrically connected to a contact 191. According to the configuration, when the first scan signal GL1 is high and the second scan signal trace GLB1 is low, the first switch SW1 is closed and the electrical potential of the data signal DL1 is applied to the contact 191. The first switch SW1 may include only the n-channel transistor or the first switch SW1 may include only the p-channel transistor. In this case, the on/off condition of the first switch SW1 may be controlled according to one kind of the scan signal.

The memory circuit 120 includes the second switch SW2 (a CMOS switch), a first invertor INV1 (a CMOS invertor), and a second invertor INV2 (a CMOS invertor). The second switch SW2 includes an n-channel transistor 121 and a p-channel transistor 122. The first invertor INV1 includes a p-channel transistor 123 and an n-channel transistor 124. The second invertor INV2 includes a p-channel transistor 125 and an n-channel transistor 126. The second switch SW2 is configured to be closed when the second scan signal GLB1 is high and the first scan signal GL1 is low. When the second switch SW2 is closed, the contact 191 is electrically connected to a contact 193. The first invertor INV1 includes an input terminal connected to the contact 191 and an output terminal connected to a contact 192. The second invertor INV2 includes an input terminal connected to the contact 192 and an output terminal connected to the contact 193.

A potential applying traces VDD1 and VSS1 are electrically connected to the first invertor INV1 and the second invertor INV2 in the memory circuit 120, respectively. The potential applying traces VDD1 and VSS1 are power supply lines of the memory circuit 120. A high level potential is constantly applied to the potential applying trace VDD1 (a memory-side potential applying trace). A low level potential is constantly applied to the potential applying trace VSS1 (a memory-side potential applying trace). According to the configuration, the memory circuit 120 holds a value based on the electrical potential at the contact 191 when the first switch SW1 is closed (a logical value) until the first switch SW1 is closed again.

The liquid crystal driving voltage applying circuit 130 includes a third switch SW3 (a CMOS switch) and a fourth switch SW4. The third switch SW3 includes a p-channel transistor 131 and an n-channel transistor 132. The fourth switch SW4 includes a p-channel transistor 133 and an n-channel transistor 134. The third switch SW3 is configured to be closed when the electrical potential at the contact 191 is high and the electrical potential at the contact 192 is low. When the third switch SW3 is closed, the electrical potential at the potential applying trace VB1 is applied to the light reflecting electrode 71. When the fourth switch SW4 is closed, the electrical potential at the potential applying trace VA1 is applied to the light reflecting electrode 71. The display component 140 includes the liquid crystal layer 31, the light reflecting electrodes 71, and the common electrode 45. The condition of the liquid crystal layer 31 is controlled based on the potential differences between the light reflecting electrodes 71 and the common electrode 45.

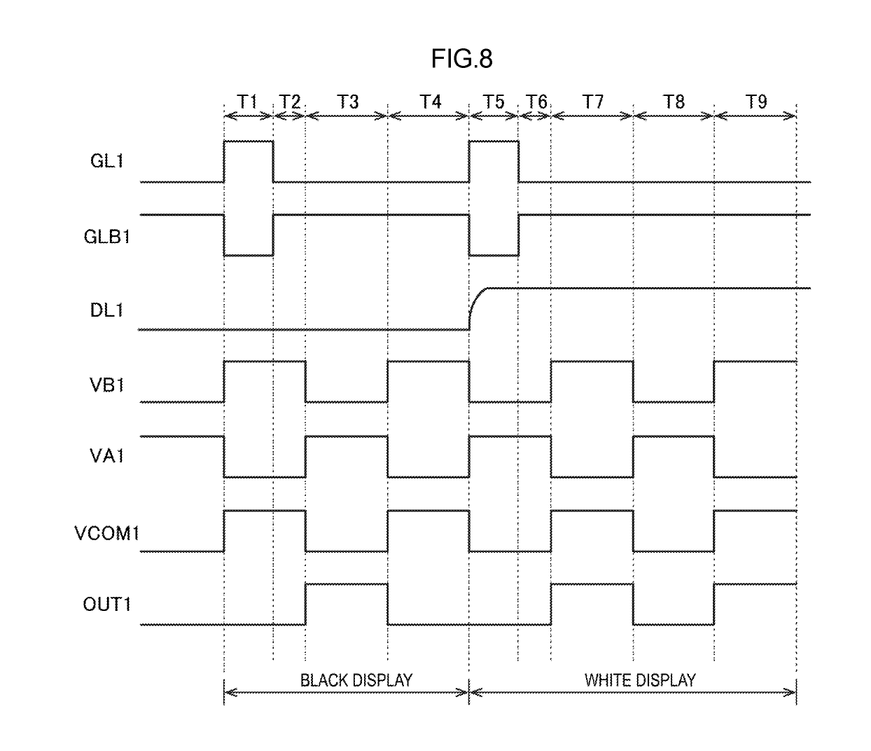

Next, operation of the pixel circuit 100 will be described with reference to FIGS. 6 and 8. FIG. 8 is a timing chart illustrating an example of operation of the pixel circuit 100, specifically, variations in electrical potential at the traces GL1, GLB1, DL1, VA1, and VB1 connected to the pixel circuit 100 and variations in electrical potential to the common electrode 45 and the light reflecting electrode 71 with time. In the following description, the reference symbols indicating the traces (the signal lines) may be used for the signals (the electrical potentials) at the traces. For example, the electrical potential VA1 is the electrical potential at the potential applying trace VA1. In FIG. 8, VCOM1 indicates an electrical potential at the common electrode 45 and OUT1 indicates an electrical potential at the light reflecting electrode 71.

The first scan signal GL1 remains high only for predefined periods (T1, T5). The second scan signal GLB1 remains low only for predefined periods (T1, T5). Namely, the first scan signal GL1 and the second scan signal GLB1 are in antiphase. A square-wave pulse signal VCOM1 that periodically repeats on and off is input to the common electrode 45. Namely, the electrical potential at the common electrode 45 periodically becomes on and off. A square-wave pulse signal that is in antiphase with the pulse signal VCOM1 is input to the potential applying trace VA1. A square-wave pulse signal that is in phase with the pulse signal VCOM1 is input to the potential applying trace VB1. The electrical potential VA1 at the potential applying trace VA1 is the same as the electrical potential VCOM1 at the common electrode 45. The electrical potential VB1 at the potential applying trace VB1 is in antiphase with the electrical potential VCOM1. Namely, the electrical potential VA1 (the second potential) is antiphase with the electrical potential VB1. The data signal DL1 is low in periods from T1 to T4 and high in periods from T5 to T9.

In period T1, the first scan signal GL1 is high and the second scan signal GLB1 is low. Therefore, the first switch SW1 is closed and the second switch SW2 is open. In this period, the data signal DL1 is low and thus the electrical potential at the contact 191 is low. Therefore, the electrical potential at the contact 192 is high and the electrical potential at the contact 193 is low. Binary data based on the data signal DL1 is stored in the memory circuit 120. Based on the electrical potentials at the contact 191 and the contact 192, the third switch SW3 is open and the fourth switch SW4 is closed. Therefore, the electrical potential VA1 at the potential applying trace VA1 is applied to the light reflecting electrode 71. In period T1, the electrical potential VA1 is low and the electrical potential OUT1 at the light reflecting electrode 71 is low. The electrical potential VCOM1 at the common electrode 45 is high. Because the liquid crystal panel 11 according to this embodiment operates in normally white mode as described above, the pixel 19 is black (with minimum transmissivity) in period T1.

In period T2, the first scan signal GL1 is low and the second scan signal GLB1 is high. Therefore, the first switch SW1 is open and the second switch SW2 is closed. Because the contact 192 is connected to the output terminal of the first invertor INV1, the electrical potential at the contact 192 remains high in this period. Furthermore, because the contact 193 is connected to the output terminal of the second invertor INV2, the electrical potential at the contact 193 remains low in this period. Because the electrical potential at the contact 193 is low and the second switch SW2 is closed, the electrical potential at the contact 191 remains low. Similar to period T1, the third switch SW3 is open and the fourth switch SW4 is closed. Therefore, the electrical potential VA1 is applied to the light reflecting electrode 71. In this period, the electrical potential VA1 is low and thus the electrical potential OUT1 at the light reflecting electrode 71 is low. Furthermore, the electrical potential VCOM1 at the common electrode 45 is high. In period T2, the pixel 19 is black. In period T4, the same operation as that in period T2 is perform and thus the pixel 19 is black.

In period T3, the same operation as that in period T2 is performed and thus the electrical potentials at the contacts 191 and 193 remain low and the electrical potential at the contact 192 remains high. Similar to periods T1 and T2, the third switch SW3 is open and the fourth switch SW4 is closed. Therefore, the electrical potential VA2 is applied to the light reflecting electrode 71. In period T3, the electrical potential VA1 is high and the electrical potential VCOM1 at the common electrode 45 is low. In period T3, the pixel is black. In periods T1 to T4, the electrical potential VA1 is applied to the light reflecting electrode 71 and the pixel 19 is black.

In period T5, the first scan signal GL1 is high and the second scan signal GLB1 is low. Therefore, the first switch SW1 is closed and the second switch SW2 is open. In this period, the data signal DL1 shifts from low to high. Therefore, the electrical potential at the contact 191 alters from the low to high. The electrical potential at the contact 192 becomes low and the electrical potential at the contact 193 becomes high. The value in the binary data stored in the memory circuit 120 is overwritten based on the variation in data signal DL1. Based on the electrical potentials at the contacts 191 and 192, the state of the third switch SW3 alters from open to closed and the state of the fourth switch SW4 alters from closed to open. As a result, the electrical potential at the potential supplying trace VB1 is applied to the light reflecting electrode 71. Because the electrical potential VB1 and the electrical potential VCOM1 are low in period T5, the pixel 19 is white.

In period T6, the first scan signal GL1 is low and the second scan signal GLB1 is high. Therefore, the first switch SW1 is open and the second switch SW2 is closed. In this period, the electrical potential at the contact 192 remains low and the electrical potential at the contact 193 remains high. Because the electrical potential at the contact 193 remains high and the second switch SW2 is closed, the electrical potential at the contact 191 remains high. Similar to period T5, the switch SW3 is closed and the fourth switch SW4 is open. As a result, the electrical potential at the potential applying traces VB1 is applied to the light reflecting electrode 71. In period T6, the electrical potential VB1 and the electrical potential VCOM1 are low and thus the pixel 19 is white. In period T8, operation similar to that in period T6 is performed. Therefore, the pixel is white.

In period T7, the electrical potentials at the contacts 191 and 193 remain high and the electrical potential at the contact 192 remains low, as in period T6. Similar to periods T5 and T6, the third switch SW3 is closed and the fourth switch SW4 is open. As a result, the electrical potential at the potential applying trace VB1 is applied to the light reflecting electrode 71. In period T7, the electrical potentials VCOM1 and VB1 are high. Therefore, the pixel 19 is white. In periods T5 to T9, the electrical potential VB1 is applied to the light reflecting electrode 71 and thus the pixel 19 is white.

As described above, in each pixel circuit 100, the binary data (the potentials at the contacts 192 and 193) are stored in the memory circuit 120 based on the potential of the data signal DL1 when the first switch SW1 is closed. The liquid crystal driving voltage applying circuit 130 selects the electrical potential to be applied to the light reflecting electrode 71 (the electrical potential VA1 or the electrical potential VB1) based on the binary data stored in the memory circuit 120. The pixel 19 exhibits either white display or black display based on the electrical potential at the light reflecting electrode 71 and the electrical potential at the common electrode 45. When the electrical potential VA1 is selected for the electrical potential at the light reflecting electrode 71, the pixel 19 is black (periods T1 to T4). When the electrical potential VB1 is selected for the electrical potential at the light reflecting electrode 71, the pixel 19 is white (in periods T5 to T9). In this embodiment, the electrical potential VB1 is a white display potential applied to exhibit white display and the electrical potential VA1 is a black display potential applied to exhibit black display.

With the pixel circuit 100, to display a still image, the binary data based on the data signal is stored in the memory circuit 120 and the image is displayed based on the data stored in the memory circuit 120. Therefore, supply of data signals from the IC chip 20 can be stopped and power consumption due to the supply of data signals can be reduced. According to the configuration in which the memory circuit 120 is provided for each pixel 19, the size of the IC chip 20 can be reduced in comparison to a configuration in which a memory circuit is provided in the IC chip 20 in the non-display area A2. Therefore, the non-display area A2 (and the size of the liquid crystal panel 11) can be reduced. In this embodiment, polarities of voltage applied across the common electrode 45 and the light reflecting electrode 71 (a difference between the electrical potential VCOM1 and the electrical potential OUT1) periodically alternate. Therefore, a voltage with the same polarity is less likely to be applied to the liquid crystal layer 31 for a long period and thus quality of the liquid crystals is less likely to decrease.

Next, the traces connected to the pixel circuits 100 will be described. As illustrated in FIG. 3, the data signal traces DL1 extends in the Y-axis direction and arranged in the X-axis direction. The number of the data signal traces DL1 is equal to the number of lines of the pixels 19 arranged in the X-axis direction. The data signal traces DL1 are connected to the respective pixel circuits 100 in the respective lines of the pixels 19 arranged in the direction in which the data signal traces DL1 extend (the Y-axis direction). The traces GL1, GLB1, VDD1, VSS1, VA1, and VB1 are arranged in the X-axis direction. The number of each kind of the traces GL1, GLB1, VDD1, VSS1, VA1, and VB1 corresponds with the number of lines of the pixels 19 in the Y-axis direction.

The first scan signal traces GL1 and the second scan signal traces GLB1 extend in the X-axis direction. The first scan signal traces GL1 and the second scan signal traces GLB1 are adjacent to each other. The first scan signal traces GL1 and the second scan signal traces GLB1 are connected to the respective pixel circuits 100 in the pixels 19 arranged in the direction in which the first scan signal traces GL1 and the second scan signal traces GLB1 extend (the X-axis direction). The potential applying traces VDD1 and the potential applying trances VSS1 extend in the X-axis direction. The potential applying traces VDD1 and the potential applying trances VSS1 are adjacent to each other. The potential applying traces VDD1 and the potential applying trances VSS1 are connected to the respective pixel circuits 100 in the pixels 19 arranged in the direction in which the potential applying traces VDD1 and the potential applying trances VSS1 extend (the X-axis direction). The circuit components of each pixel circuit 100 (the first switch SW1, the memory circuit 120, the liquid crystal driving voltage applying circuit 130) are formed at positions that overlap the light reflecting electrode 71 on the first circuit board 11A in a plan view (when viewed in a direction normal to the display surface 12A).

As described above, each pixel 19 in this embodiment includes the light reflecting display area R1 and the light transmitting display area H1. The portions of the traces connected to the pixel circuit 100 overlap the light transmitting display area H1 in a plan view (when viewed in the direction normal to the display surface 12A). In the following description, the portion of the first scan signal trace GL1 overlapping the light transmitting display area H1 in the plan view will be referred to as an overlapping portion GL2 and the portion of the second scan signal trace GLB1 overlapping the light transmitting display area H1 in the plan view will be referred to as an overlapping portion GLB2. The portion of the potential applying trace VDD1 overlapping the light transmitting display area H1 in the plan view will be referred to as an overlapping portion VDD2 and the portion of the potential applying trace VSS1 overlapping the light transmitting display area H1 in the plan view will be referred to as an overlapping portion VSS2. The portion of the potential applying trace VA1 overlapping the light transmitting display area H1 in the plan view will be referred to as an overlapping portion VA2 and the portion of the potential applying trace VB1 overlapping the light transmitting display area H1 in the plan view will be referred to as an overlapping portion VB2. The portion of the data signal trace DL1 overlapping the light transmitting display area H1 in the plan view will be referred to as an overlapping portion DL2.

As illustrated in FIG. 4, each data signal trace DL1 is formed on the first insulating film 64 between the first insulating film 64 and the second insulating film 65. As illustrated in FIG. 5, each first scan signal trace GL1 and each second scan signal trace GLB1 are formed on the glass substrate 61 between the glass substrate 61 and the first insulating film 64. Each potential applying trace VDD1 and each potential applying trace VSS1 are formed on the glass substrate 61 between the glass substrate 61 and the first insulating film 64. Each potential applying trace VA1 and each potential applying trace VB1 are formed on the glass substrate 61 between the glass substrate 61 and the first insulating film 64. Namely, the overlapping portions GL2, GLB2, VDD2, VSS2, VA2, and VB2 are between the glass substrate 61 and the first insulating film 64. In this description, “each trace” refers to each trace GL1, GLB1, VDD1, VSS1, VA1, or VB1 and “each overlapping portion” refers to each overlapping portion GL2, GLB2, VDD2, VSS2, VA2, or VB2.

To form each transistor in each pixel circuit 100, the gate electrode of the transistor may be formed on the glass substrate 61, and the drain electrode and the source electrode may be formed on the first insulating film 64. If the drain electrode and the source electrode of the transistor are formed on the first insulating film 64, the traces (the potential applying trace VDD1, the potential applying trace VSS1, the potential applying trace VA1, the potential applying trace VB1) are connected to the drain electrode or the source electrode via contact holes. In the configuration in which the traces VDD1, VSS1, VA1, and VB1 are formed on the first insulating film 64, such contact holes are not required. In this embodiment, the traces VDD1, VSS1, VA1, and VB1 are formed on the glass substrate 61 (between the glass substrate 61 and the first insulting film 64) rather than the first insulating film 64 to restrict the orientation of the liquid crystals in the liquid crystal layer 31 from altering due to differences in potentials between the common electrode 45 and the overlapping portions VDD2, VSS2, VA2, and VB2 (will be described in detail later).

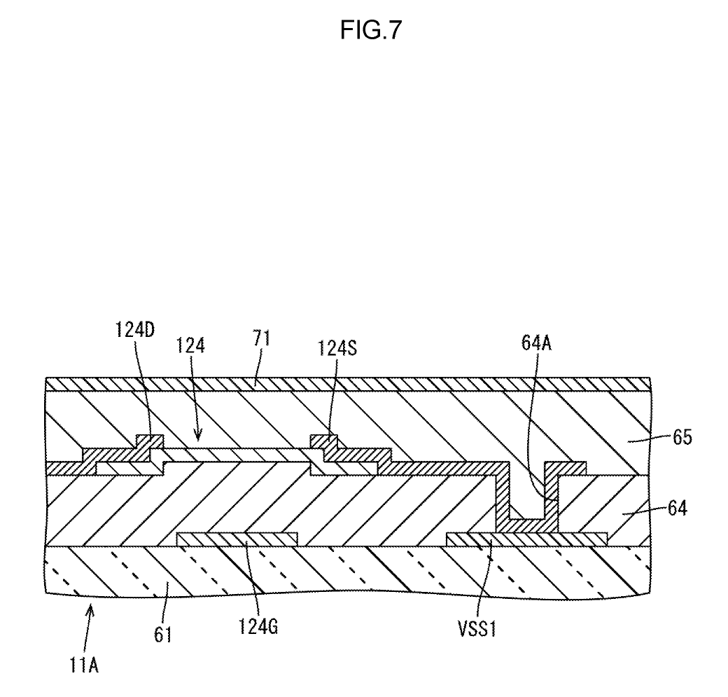

A configuration of the n-channel transistor 124 in the memory circuit 120 of the pixel circuit 100 is illustrated in FIG. 7. As illustrated in FIG. 7, a gate electrode 124G of the n-channel transistor 124 is formed on the glass substrate 61 and a drain electrode 124D and a source electrode 124S of the n-channel transistor 124 are formed on the first insulating film 64. As illustrated in FIG. 6, the potential applying trace VSS1 is connected to the source electrode 124S. As illustrated in FIG. 7, the potential applying trace VSS1 formed on the glass substrate 61 is connected to the source electrode 124S via a contact hole 64A. The layer of the first circuit board 11A in which the transistor in the pixel circuit 100 is formed may be altered as appropriate, that is, not limited to the configuration illustrated in FIG. 7.

As illustrated in FIG. 5, light blocking portions 51 are formed in areas of the second circuit board 11B overlapping the overlapping portions GL2 and the overlapping portions GLB2 in the plan view. Light blocking portions 52 are formed in areas of the second circuit board 11B overlapping the overlapping portions VDD2 and the overlapping portions VSS2 in the plan view. Light blocking portions 53 are formed in areas of the second circuit board 11B overlapping the overlapping portions VB2 in the plan view. The spacers 17 are disposed at positions overlapping the overlapping portions VB2 in the plan view. Light blocking portions 54 are formed in areas of the second circuit board 11B overlapping the overlapping portions DL2 of the data signal traces DL1 (see FIG. 3). The light blocking portions 51, 52, 53, and 54 are formed on the surface of the common electrode 45 on the liquid crystal layer 31 side to block light transmitting through the liquid crystal layer 31 and traveling to the second circuit board 11B. The light blocking portions 51, 52, and 53 are made of metal such as chrome or resin with light blocking members dispersed therein. The resin may be polyimide or acrylic. A black pigment used for the light blocking material may be carbon black or titanium black. The material of the light blocking portions 51, 52, 53, and 54 is not limited to the material described above and a different material may be used as appropriate.

As illustrated in FIG. 3, each light blocking portion 51 has a square two-dimensional shape and covers the corresponding overlapping portions GL2 and GLB2 (a pair of overlapping portions) which are adjacent to each other. The light blocking portion 51 has a dimension Y1 in a direction in which the overlapping portions GL2 and GLB2 are adjacently arranged (the Y-axis direction, the horizontal direction in FIG. 5) is larger than a dimension Y3 that is a sum of dimensions of the overlapping portions GL2 and GLB2 and a distance between the overlapping portions GL2 and GLB2 in the direction. According to the configuration, the overlapping portions GL2 and GLB2 are properly covered with the light blocking portion 51. As illustrated in FIG. 3, a dimension of the light blocking portion 51 in the X-axis direction is larger than a dimension of the light transmitting display area H1 in the X-axis direction. According to the configuration, the light transmitting through the light transmitting display area H1 is properly blocked by the light blocking portion 51.

Each light blocking portion 52 has a size for covering the corresponding overlapping portions VDD2 and VSS2 adjacent to each other (a pair of overlapping portions). The light blocking portion 52 has a dimension Y2 in a direction in which the overlapping portions VDD2 and VSS2 are adjacently arranged (the Y-axis direction, the horizontal direction in FIG. 5) larger than a dimension Y4 that is a sum of dimensions of the overlapping portions VDD2 and VSS2 and a distance between the overlapping portions VDD2 and VSS2 in the direction. According to the configuration, the overlapping portions VDD2 and VSS2 are properly covered with the light blocking portion 52. As illustrated in FIG. 3, the dimension of the light blocking portion 52 in the X-axis direction is larger than a dimension of the light transmitting display area H1 in the X-axis direction. According to the configuration, the light transmitting through the light transmitting display area H1 is properly blocked by the light blocking portion 52. The light blocking portion 53 has a square two-dimensional shape and covers only the overlapping portion VB2 of the overlapping portions VA2 and VB2 that are adjacent to each other and do not overlap the overlapping portion VA2.

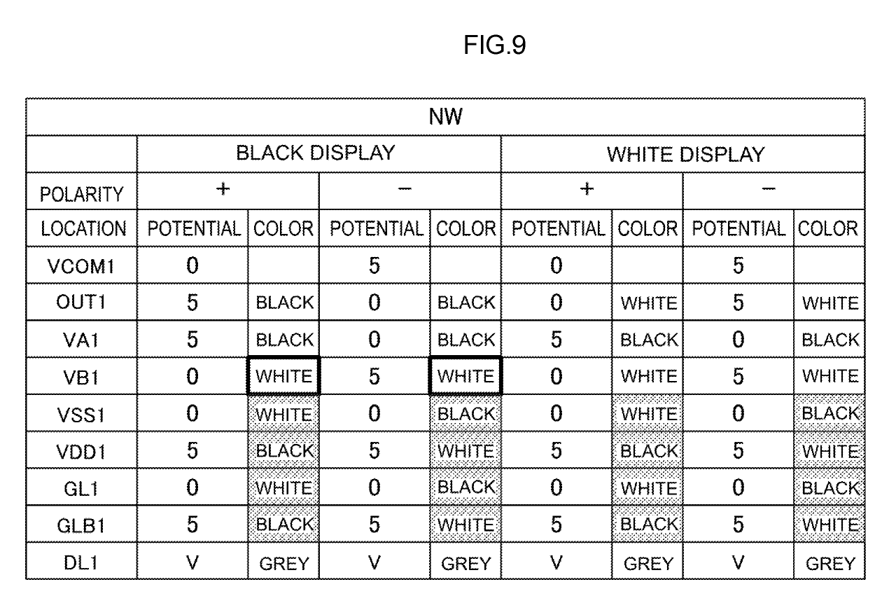

Next, advantageous effects of this embodiment will be described. As described earlier, the portions of the traces connected to the pixel circuits 100 (the overlapping portions) are in the light transmitting display areas H1. In the light transmitting display areas H1, the light reflecting electrodes 71, which are the pixel electrodes, are not provided. Therefore, the orientation of the liquid crystals in the liquid crystal layer 31 may vary due to the electrical potentials at the traces (the overlapping portions). FIG. 9 is a table that represents electrical potentials at the traces VA1, VB1, VSS1, VDD1, GL1, and GLB1 in the pixel circuit 100 and the electrical potentials at the electrodes 45 and 71 according to this embodiment. The electrical potentials for black display and white display are present in FIG. 9. Voltage of 5 V and 0 V represent high and low, respectively. In FIG. 9, “black” represents a condition that a potential difference is observed between the common electrode 45 (electrical potential VCOM1) and each trace and “white represents a condition that no potential difference is observed between the common electrode 45 and each trace. The electrical potentials at the data signal traces DL1 differs according to the image data and are not constant. Therefore, “grey” is entered in cells representing colors regarding the data trace DL1. Black display in FIG. 9 corresponds to periods T2 to T4 in FIG. 8 and white display in FIG. 9 corresponds to periods T6 to T9 in FIG. 8.

As described earlier, in this embodiment, each pixel circuit 100 operates while altering the polarities of the electrical potential VCOM1 at the common electrode 45 and the electrical potential OUT1 at the light reflecting electrode 71 to reduce deterioration of liquid crystals in the liquid crystal layer 31. As illustrated in FIG. 9, the electrical potentials VSS1, VDD1, GL1, and GLB1 are constant (high or low) regardless of the polarities of the voltages at the common electrode 45 and the light reflecting electrode 71. The level of electrical potential VCOM1 at the common electrode 45 periodically alters between high and low according to a pulse signal fed to the common electrode 45. Therefore, the potential differences between the common electrode 45 and the first scan signal trace GL1, the second scan signal trace GLB1, the potential applying trace VDD1, and the potential applying trace VSS1 periodically vary. If the potential differences between the common electrode 45 and the overlapping portions of the first scan signal trace GL1, the second scan signal trace GLB1, the potential applying trace VDD1, and the potential applying trace VSS1 affect the orientation of the liquid crystals in the liquid crystal layer 31, the white display and the black display may be repeated in the areas corresponding to the overlapping portions every time when the polarity of the electrical potential at the common electrode 45 is reversed, which may result in flickers (see shaded cells in FIG. 9).

The electrical potential at the potential applying trace VB1 is at the same level as the electrical potential VCOM1 at the common electrode 45. If the potential difference between the overlapping portion VB2 of the potential applying trace VB1 and the common electrode 45 affects the orientation of the liquid crystals, the area corresponding to the overlapping portion VB2 is constantly white. In the liquid crystal display device 10, a white display in the area corresponding to the overlapping portion VB2 during a black display may be detected as a bright dot defect.

In this embodiment, the traces (the first scan signal trace GL1, the second scan signal trace GLB1, the potential applying trace VDD1, the potential applying trace VSS1, the potential applying trace VA1, and the potential applying trace VB1) are formed on the glass substrate 61. The first insulating film 64 and the second insulating film 65 are formed between the liquid crystal layer 31 and the overlapping portions GL2, GLB2, VDD2, VSS2, VA2, and VB2. In comparison to a configuration that does not include the first insulating film 64 and the second insulating film 65, the overlapping portions GL2, GLB2, VDD2, VSS2, VA2, and VB2 are isolated from the liquid crystal layer 31. According to the configuration, the orientation of the liquid crystals in the liquid crystal layer 31 is less likely to alter due to the potential difference between the common electrode 45 and the overlapping portions GL2, GLB2, VDD2, VSS2, VA2, and VB2. Therefore, the bright dot defect or the flicker is less likely to be produced in the areas of the light transmitting display area H1 corresponding to the overlapping portions GL2, GLB2, VDD2, VSS2, VA2, and VB2 and thus higher display quality is achieved.

In this embodiment, the light blocking portions 51, 52, and 53 are formed in the areas corresponding to the overlapping portions GL2, GLB2, VDD2, VSS2 in which the flicker may be produced and the overlapping portions VB2 in which the bright dot defects may be produced. According to the configuration, the areas in the liquid crystal display device 10 corresponding to the light blocking portions 51, 52, and 53 (the overlapping portions) are always black. Therefore, the flicker or the bright dot defect due to the electrical potential at the overlapping portions GL2, GLB2, VDD2, and VSS2 are further less likely to be produced. As illustrated in FIG. 9, the area corresponding to the overlapping portion VA2 of the potential applying trace VA1 may be constantly black. If the area is black, the flicker or the bright dot defect is not produced in the area corresponding to the overlapping portion VA2. This embodiment is configured to cover the overlapping portions in which the flicker or the bright dot defect may be produced with the light blocking portions in view of a relationship between the electrical potential at the common electrodes and the electrical potentials at the traces (the overlapping portions). According to the configuration, the light blocking portions are provided in proper sizes and thus a decrease in light use efficiency is less likely to occur.

Each light blocking portion 51 covers the overlapping portions GL2 and GLB2 that are adjacent to each other. Each light blocking portion 52 covers the overlapping portions VDD2 and VSS2 that are adjacent to each other. If the adjacent overlapping portions are covered with separate light blocking portions, respectively, light may leak through a gap between the light blocking portions. In this embodiment, the adjacent overlapping portions are covered with a single light blocking portion and thus the leakage of light is less likely to occur. Therefore, higher display quality is achieved.

To properly block the light traveling to the second circuit board 11B with the light blocking portions, it is preferable to set the dimensions of the light blocking portions in the width direction of the traces larger than the dimensions of the overlapping portions in the width direction such that the light blocking portions include portions to cover peripheries of the overlapping portions (peripheral portions). If two operating portions that are not adjacent to each other are covered with separate light blocking portions, respectively, it is preferable that each of the light blocking portions includes the peripheral portion. Therefore, the total area of the light blocking portion increases. In this embodiment, the overlapping portions that are adjacent to each other are covered with a single light blocking portion. In comparison to the configuration in which two overlapping portions that are not adjacent to each other are covered with the separate light blocking portions, the peripheral portion (specifically, a portion corresponding to an area between the overlapping portions) is reduced. Therefore, the area of the light blocking portion can be reduced and higher light use efficiency can be achieved.

In this embodiment, the spacers 17 are disposed to overlap the overlapping portions VB2 and the light blocking portions 53 in the plan view. It is difficult to adjust the orientation of the liquid crystals in areas around the spacers 17 and thus the display quality may decrease. With the light blocking portions 53 that are formed to overlap the spacers 17, the display quality is less likely to decrease. Furthermore, the spacers 17 and the overlapping portions VB2 overlap each other. Therefore, a single light blocking portion 53 can cover the corresponding spacer 17 and the corresponding overlapping portion VB2. In a configuration in which the spacer 17 and the overlapping portion VB2 that are separately arranged are covered with separate light blocking portions, the area of the light blocking portion can be reduced and the higher light use efficiency can be achieved.

### Second Embodiment

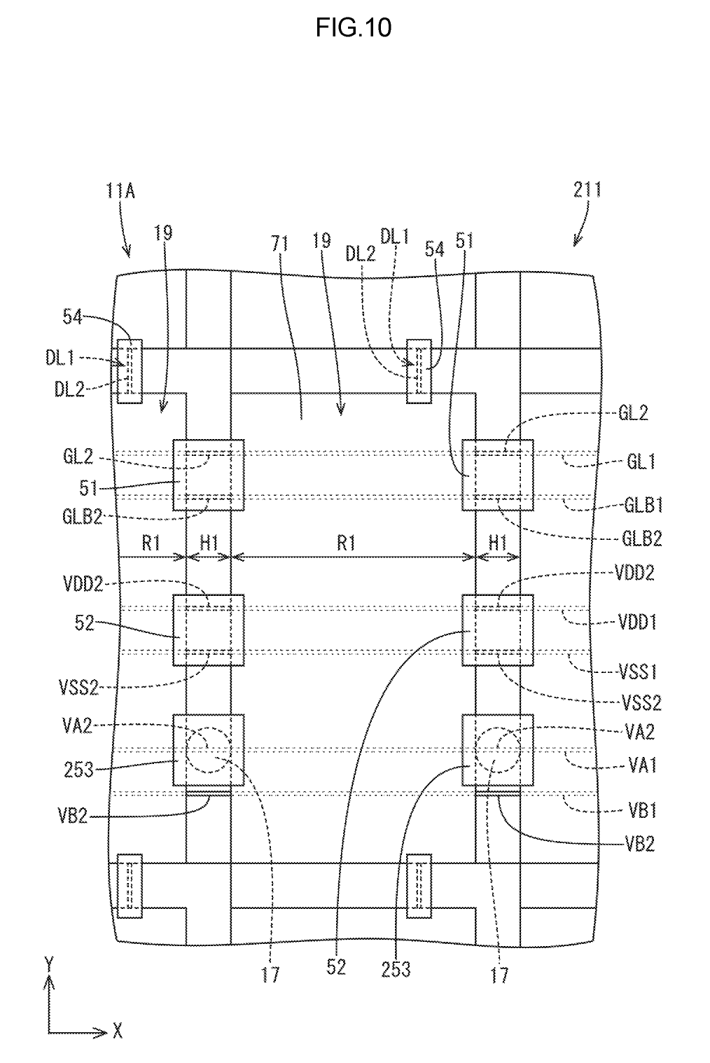

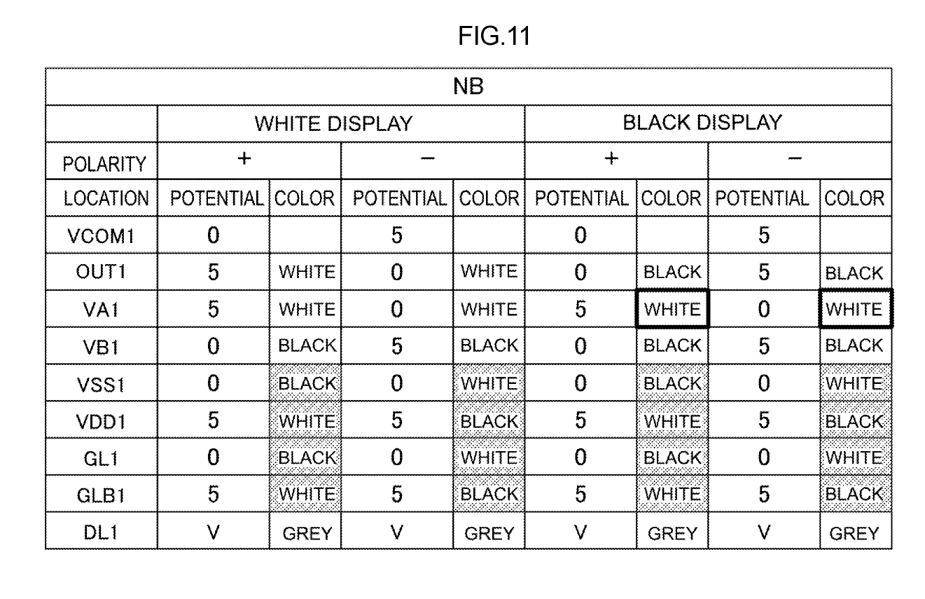

A second embodiment according to the present invention will be described with reference to FIGS. 10 and 11. The second embodiment includes a liquid crystal panel 211 having a configuration different from the liquid crystal display device according to the first embodiment. The liquid crystal panel 211 in this embodiment operates in normally black mode in which the light transmissivity is at a minimum and a display is black when no power is supplied (no voltage is applied to the light reflecting electrodes 71). As illustrated in FIG. 10, this embodiment includes light blocking portions 253 that overlap the overlapping portions VA2 of the potential applying traces VA1. The light blocking portions 253 are formed on a surface of the common electrode 45 on the liquid crystal layer 31 side, similar to the light blocking portions 51 and 52. In this embodiment, the overlapping portions VB2 of the potential applying traces VB1 are not covered with the light blocking portions.

FIG. 11 is a table that represents electrical potentials at the traces VA1, VB1, VSS1, VDD1, GL1, and GLB1 and electrical potentials at the electrodes 45 and 71. In FIG. 11, voltage of 5 V and 0 V represent high and low, respectively. Each pixel circuit 100 in this embodiment has the same configuration and operates in the same manner as the first embodiment. Therefore, the electrical potentials at the traces are the same as the electrical potentials in the first embodiment (see FIG. 9). The liquid crystal panel 211 in this embodiment operates in normally black mode. In this embodiment, when the electrical potential at the potential applying trace VA1 is applied to the light reflecting electrode 71 (a potential difference is produced between a light common electrode 45 and the common electrode 45), the pixel 19 becomes white. When the electrical potential at the potential applying trace VB1 is applied to the light reflecting electrode 71 (no potential difference is produced between the light common electrode 45 and the common electrode 45), the pixel 19 becomes black. In this embodiment, the potential applying trace VA1 (a first potential applying trace in normally black mode) is a trace for applying the electrical potential for a white display. The potential applying trace VB1 is a trace for applying the electrical potential for a black display. If a potential difference is produced between the common electrode 45 and the overlapping portions, the white display may be produced. If no potential difference is produced between the common electrode 45 and the overlapping portions, the black display may be produced. In FIG. 11, “white” is entered if the potential difference is observed between the common electrode 45 (the electrical potential VCOM1) and the traces. If no potential difference is observed between the common electrode 45 and the traces, “black” is entered.

Similar to the first embodiment, this embodiment operates while the polarities of the electrical potential VCOM1 at the common electrode 45 and the electrical potential OUT1 at the light reflecting electrode 71 are altered. The electrical potentials VSS1, VDD1, GL1, and GLB1 are at a specific level (high or low). The potential differences between the common electrode 45 and the overlapping portions of the first scan signal trace GL1, the second scan signal trace GLB1, the potential applying trace VDD1, and the potential applying trace VSS1 vary with time. If the potential differences between the common electrode 45 and the overlapping portions of the first scan signal trace GL1, the second scan signal trace GLB1, the potential applying trace VDD1, and the potential applying trace VSS1 affect the orientation of the liquid crystals, the white display and the black display are repeatedly and periodically produced in the areas corresponding to the overlapping portions, resulting in flickers (see shaded cells in FIG. 11).

The electrical potential at the potential applying trace VA1 (a first potential applying trace) is in antiphase with the electrical potential VCOM1 at the common electrode 45. If the potential difference between the common electrode 45 and the overlapping portion VA2 of the potential applying trace VA1 affects the orientation of the liquid crystals, the area corresponding to the overlapping portion VA2 is constantly white. In the liquid crystal display device 10, the area corresponding to the overlapping portion VA2 in white during the black display may be detected as a bright dot defect.

In this embodiment, the potential applying traces VA1 are formed on the glass substrate 61. According to the configuration, the electrical potentials at the overlapping portions VA2 are less likely to affect the orientation of the liquid crystals in the liquid crystal layer 31. Furthermore, the light blocking portions 253 cover the overlapping portions VA2. According to the configuration, the areas of the liquid crystal panel 211 corresponding to the overlapping portions VA2 are less likely to become white and thus the bright dot defects are less likely to be produced. As illustrated in FIG. 11, the areas corresponding to the overlapping portions VB2 of the potential applying traces VB1 may be constantly black. As long as the areas are black, the flickers or the bright dot defects are not produced in the areas corresponding to the overlapping portions VB2. Therefore, the overlapping portions VB2 are not covered with the light blocking portions in this embodiment and thus the light use efficiency is less likely to decrease.

### Third Embodiment

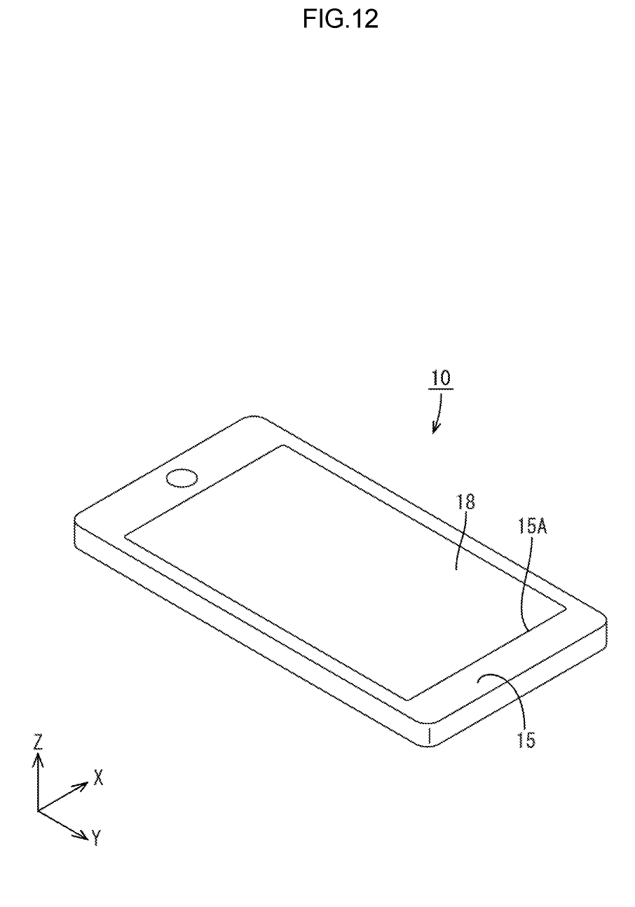

A third embodiment according to the present invention will be described with reference to FIG. 12. The liquid crystal display device 10 according to this embodiment is configured for a smartphone, which is a mobile device. As illustrated in FIG. 12, the liquid crystal display device 10 (the smartphone) has a vertically-long rectangular overall shape. The liquid crystal display device 10 includes an exterior member 15 that is a case and a cover panel 18 (a protective panel, a cover glass). The exterior member 15 includes an opening 15A and the cover panel is attached over the opening 15A. A touch panel (not illustrated) is disposed between the cover panel 18 and the liquid crystal panel 11. With the liquid crystal display device 10, the mobile device with high display quality is provided. As described in the above embodiment section, in the liquid crystal display device 10, the ambient light is reflected by the light reflecting electrodes 71 and used for display. Because the liquid crystal display device 10 includes the pixel circuits 100, the power consumption can be reduced. Therefore, the liquid crystal display device 10 is suitable for application to a mobile device such as a smartphone. The liquid crystal display device 10 may be applied to mobile devices other than the smartphone including feature phones and watches.

### Other Embodiments

The present invention is not limited to the embodiments described above and illustrated by the drawings. For example, the following embodiments will be included in the technical scope of the present invention.

(1) The above embodiments may not include the light blocking portions 53. The light traveling toward the second circuit board 11B may be blocked by the spacers 17. In the above embodiments, the spacers 17 overlap the potential applying traces VA1 (the overlapping portions VA2) or the potential applying traces VB1 (the overlapping portions VB2). However, the spacers 17 may be arranged to overlap the overlapping portions VSS2, VDD2, GL2, GLB2, or DL2 of the traces related to the pixel circuits 100 to block the light traveling toward the second circuit board 11B.

(2) In each of the above embodiments, the traces (the first scan signal traces GL1, the second scan signal traces GLB1, the potential applying traces VDD1, the potential applying traces VSS1, the potential applying traces VA1, and the potential applying traces VB1) are formed on the glass substrate 61. However, only the overlapping portions GL2, GLB2, VDD2, VSS2, VA2, and VB2 of the traces may be between the glass substrate 61 and first insulating film 64 and portions of the traces other than the overlapping portions may be formed on the first insulating film 64.

(3) In each of the above embodiments, two overlapping portions of two traces (e.g., the overlapping portions VDD2 and VSS2) are covered with a single light blocking portion (e.g., the light blocking portion 52). However, three or more overlapping portions may be covered with a single light blocking portion.

(4) The overlapping portions VA2 of the potential applying traces VA1 and the overlapping portions VB2 of the potential applying traces VB1 in each of the above embodiments may be covered with the light blocking portions. According to the configuration, the bright dot defects are less likely to be produced in the overlapping portions VA2 (or the overlapping portions VB2) regardless of the operating modes, that is, the normally black mode and the normally white mode.

(5) The arrangement of the light blocking portions is not limited to the arrangement in each of the above embodiments (which defines what overlapping portions are covered with the light blocking portions among the overlapping portions VSS2, VDD2, GL2, GLB2, DL2, VA2, and VB2 of the traces related to the pixel circuits 100) and may be altered as appropriate. For example, the overlapping portions VA2 of the potential applying traces VA1 and the overlapping portions VB2 of the potential applying traces VB1 may not be covered with the light blocking portions.

### EXPLANATION OF SYMBOLS

10: liquid crystal display device, 11A: first circuit board, 11B: second circuit board, 17: spacers, 31: liquid crystal layer, 45: common electrode, 51, 52, 53, 253: light blocking portion, 61: glass substrate (transparent substrate), 64: first insulating film, 65: second insulating film, 71: light reflecting electrode, 120: memory circuit (memory portion), 130: liquid crystal driving voltage applying circuit (potential adjusting portion), DL1: data signal trace, GL1: first scan signal trace (one of traces included in a pair together with the second scan signal trace), GL2: overlapping portion (one of overlapping portion in a pair), GLB1: second scan signal trace (one of traces in a pair), GLB2: overlapping portion (one of overlapping portions in a pair), VDD1: potential applying trace (memory-side potential applying trace, one of the traces included in a pair together with the potential applying trace VSS1), VDD2: overlapping portion (one of overlapping portions in a pair), VSS1: potential applying trace (memory-side potential applying trace, one of traces in a pair), VSS2: overlapping portion (one of overlapping portions in a pair), VA1: potential applying trace (first potential applying trace in normally black mode), VA2: overlapping portion, VB1: potential applying trace (first potential applying trace in normally white mode), VB2: overlapping portion, H1: light transmitting display area.

1. A liquid crystal display device comprising:
a transparent substrate;
a first circuit board including:
a first insulating film formed on the transparent substrate;
a second insulating film formed on the first insulating film; and
a light reflecting electrode formed on the second insulating film for reflecting light to be used for display;
a second circuit board including a common electrode opposed to the light reflecting electrode;
a liquid crystal layer between the first circuit board and the second circuit board;
a light transmitting display area in which light entering from an outer side of the first circuit board and transmitting through the first circuit board to be provided for the light for display;
a data signal trace included in the first circuit board and receiving a data signal;
a memory portion included in the first circuit board and storing data based on an electrical potential at the data signal trace;
a potential adjusting portion included in the first circuit board and controlling an electrical potential at the light reflecting electrode based on the data stored in the memory portion; and
at least one trace included in the first circuit board, the at least one trace including an overlapping portion overlapping the light transmitting display area, the at least one trace being arranged between the transparent substrate and the first insulating film and electrically connected to at least one of the memory portion and the potential adjusting portion.

2. The liquid crystal display device according to claim 1, wherein
a square-wave pulse signal is applied to the common electrode, and
the at least one trace includes a memory-side potential applying trace for applying a constant level of electrical potential to the memory portion.

3. The liquid crystal display device according to claim 1, wherein
the liquid crystal display device operates in normally white mode,
the potential adjusting portion is configured to apply one of a first potential and a second potential that is in antiphase with the first potential to the light reflecting electrode based on the data stored in the memory portion,
the at least one trace includes at least first potential applying trace for applying the first potential to the potential adjusting portion, and
a potential the same as the potential at the common electrode is applied to the first potential applying trace.

4. The liquid crystal display device according to claim 1, wherein
the liquid crystal display device operates in normally black mode,
the potential adjusting portion is configured to apply one of a first potential and a second potential that is in antiphase with the first potential to the light reflecting electrode based on the data stored in the memory portion,
the at least one trace includes at least first potential applying trace for applying the first potential to the potential adjusting portion, and
a potential that is in antiphase with the potential at the common electrode is applied to the first potential applying trace.

5. The liquid crystal display device according to claim 1, wherein
the second circuit board includes a light blocking portion for blocking light traveling to the second circuit board,
the light blocking portion is formed at a position overlapping the overlapping portion,
the at least one trace includes at least two traces included in the first circuit board,
the light blocking portion covers overlapping portions of the traces adjacent to each other, and
the light blocking portion has a dimension in a direction in which the overlapping portions are arranged adjacent to each other larger than a sum of dimensions of the overlapping portions and a distance between the overlapping portions in the direction.

6. The liquid crystal display device according to claim 1, further comprising a spacer between the first circuit board and the second circuit board for maintaining a gap between the first circuit board and the second circuit board, wherein
the second circuit board includes a light blocking portion for blocking light traveling to the second circuit board,
the light blocking portion is formed at a position overlapping the overlapping portion,
the spacer overlaps the overlapping portion.

7. The liquid crystal display device according to claim 1, wherein the liquid crystal display device is applied to a mobile device.
